(19) United States
(12) Patent Application Publication
(10) Pub. No.: US 2006/0187907 A1
(43) Pub. Date: Aug. 24, 2006

(54) Apparatus and method for switching data packets

(75) Inventors: Robert Douglas Kinsman, Stone (GB); Ian David McCarthy, Helmshore (GB); Ian David Johnson, Ferring (GB)

Correspondence Address: PILLSBURY WINTHROP SHAW PITTMAN, LLP, P.O. BOX 10500, MCLEAN, VA, 22102, US

(73) Assignee: Xyratex Technology Limited, Hampshire (GB)

(21) Appl. No.: 10/546,923

(22) PCT Filed: Mar. 1, 2004
(86) PCT No.: PCT/GB04/00847

§ 371 Date: Aug. 25, 2005

Related U.S. Application Data
(60) Provisional application No. 60/450,683, filed on Mar. 3, 2003.

(51) Int. Cl. H04L 12/50

(52) U.S. Cl. 370/360; 370/474

(57) ABSTRACT

A method and apparatus (1) is disclosed for switching data packets. A data packet is received from an input interface device (7) at one of a plurality of initial input ports (6). The data packet is divided into plural smaller data fragments. Each data fragment is passed to a respective one of a plurality of slices of an input port (3) of a core switch (2). The data fragments are switched using the core switch (2) so as to pass each data fragment to a selected respective one of a plurality of slices of an output port (3) of the core switch (2). The data fragments are then passed to a selected one of a plurality of ultimate output ports (5′). The data fragments are assembled to reform the data packet, and the reformed data packet is transmitted to an output interface device (7) connected to said selected one of a plurality of ultimate output ports (5′).

The present invention relates to apparatus and a method for switching data packets.

There is an ever increasing demand to move large amounts of digital data from one device to another. Typical applications include data communications between computers or other digital devices across a network (which may be for example a local area network, a system area network, a storage area network, or a wide area network, and more loosely coupled networks such as the Internet). There are for example many applications where data is stored at a data storage device in one physical location and it is necessary to move the data to another physical location. There is also an increasing use of digital voice data for telephone calls, video-conferencing, video-on-demand and the like. There is a growing need not only to move large amounts of data, but to do so quickly. Almost all networks ultimately require one or more switches that can switch the data travelling along the network from one path to another so that the data can pass from its source to its destination. The currently available switches that are capable of handling large amounts of data per second can only switch the data relatively slowly and therefore have relatively high latency.

Various data switches and methods of switching of data are disclosed in WO-A-02/063826, WO-A-00/038375 and WO-A-99/43131, the entire contents of which are hereby incorporated by reference. The switches have plural bidirectional ports, each having an input portion and an output portion. For clarity and by convention, these portions will be described herein generally as though they are input and output ports. Thus, the switches have plural input ports and plural output ports which are interconnected by a switching matrix which operates under the control of a control unit in order to form connections between selected ones of the input and output ports. The input ports have so-called virtual output queues for each of the output ports, which assist in preventing blocking of the output ports.

According to a first aspect of the present invention, there is provided a method of switching data packets received at initial input ports from input interface devices to output interface devices connected to ultimate output ports, the method comprising: receiving a data packet from an input interface device at one of a plurality of initial input ports; dividing the data packet into plural smaller data fragments; passing each data fragment to a respective one of a plurality of slices of an input port of a core switch; switching the data fragments using the core switch so as to pass each data fragment to a selected respective one of a plurality of slices of an output port of the core switch; passing the data fragments to a selected one of a plurality of ultimate output ports; assembling the data fragments to reform the data packet; and, transmitting the reformed data packet to an output interface device connected to said selected one of a plurality of ultimate output ports.

The method enables switching of large amounts of data in a very short time. The received data packet is relatively long in the time domain. By dividing this long data packet into smaller data fragments, which are shorter in the time domain, and switching the data fragments rather than the data packet as such, it becomes possible to switch effectively the same amount of data in a shorter time than if the data packet were switched as a whole. Typically, the data fragments arrive consecutively from an input interface device, but once divided, the fragments are switched simultaneously or nearly so.

In a preferred embodiment, the initial input ports are provided by input ports of an input edge switch that has output ports respectively connected to the slices of said input port of the core switch, the input edge switch carrying out the division of the data packet into plural smaller data fragments. The input edge switch provides a convenient mechanism for connecting to the input port of the core switch and for dividing the received data packets into plural smaller data fragments.

In a preferred embodiment, the ultimate output ports are provided by output ports of an output edge switch that has input ports respectively connected to the slices of said output port of the core switch, the output edge switch carrying out the reforming of the data packet from the data fragments. Again, the output edge switch provides a convenient mechanism for connecting to the output port of the core switch and for reforming the data packet from the data fragments.

In a most preferred embodiment, the core switch has plural input ports to each of which is connected a respective input edge switch, and the core switch has plural output ports to each of which is connected a respective output edge switch.

Thus, the preferred embodiment makes use of a plurality of data switches that are arranged and controlled so as to achieve a behaviour that is similar to that of a single-stage non-blocking switch, providing virtual cut-through routing and in-order delivery of data.

Preferably, flow control information is passed from at least some of the output interface devices to at least some of the input interface devices, said input interface devices being controlled by the flow control information so as to pass a data packet to the initial input ports only when the flow control information relating to the destination output interface device for the data packet indicates that said destination output interface device is able to accept the data packet. The ability of the destination output interface device to accept data may be determined by various factors, including for example the amount of storage space in buffers, bandwidth allocation, and/or fairness mechanisms in the interface device. Most preferably, flow control information is passed from each of the output interface devices to each of the input interface devices. Passing back of flow control information from the output interface devices to the input interface devices can be used to prevent or at least minimise blocking of the output ports. In the preferred embodiment, every input interface device knows the status of every data flow to every output interface device and schedules transfers of data fragments into the core switch only when it knows that the destination output interface device is unblocked. In one embodiment, the flow control information is passed from the output interface devices to the input interface devices by a control information switch.

According to a second aspect of the present invention, there is provided apparatus for switching data packets received at initial input ports from input interface devices to output interface devices connected to ultimate output ports, the apparatus comprising: a plurality of initial input ports for receiving data packets from input interface devices connected to the initial input ports; a divider for dividing each data packet received at the initial input ports into plural smaller data fragments; a core switch having at least one input port that has plural slices each arranged to receive a respective data fragment of a data packet, the core switch having at least one output port that has plural slices, the core switch being controllable to switch said data fragments so as to pass each data fragment to a selected respective one of the plural slices of said at least one output port of the core switch; and, an assembler for receiving the data fragments from said at least one output port of the core switch, for reforming the data packet from the data fragments, and for transmitting the reformed data packet to an output interface device connected to one of a plurality of ultimate output ports of the apparatus.

In an embodiment, the apparatus comprises an input edge switch, the input edge switch having input ports that provide the initial input ports, the input edge switch having output ports respectively connected to the slices of the at least one input port of the core switch, the input edge switch being arranged to carry out the division of a data packet into plural smaller data fragments.

In an embodiment, the apparatus comprises an output edge switch, the output edge switch having output ports that provide the ultimate output ports, the output edge switch having input ports respectively connected to the slices of the at least one output port of the core switch, the output edge switch being arranged to carry out the reforming of a data packet from data fragments.

In the most preferred embodiment, the core switch has plural input ports to each of which is connected a respective input edge switch, and the core switch has plural output ports to each of which is connected a respective output edge switch.

Preferably, the apparatus comprises a flow control information device for passing flow control information from at least some of said output interface devices connected to the ultimate output ports to at least some of said input interface devices connected to the initial input ports so as to control said input interface devices to pass a data packet to the initial input ports only when the flow control information relating to a destination output interface device for the data packet indicates that a said destination output interface device is able to accept the data packet. Most preferably, the flow control information device is arranged to pass flow control information from each of said output interface devices connected to the ultimate output ports to each of said input interface devices connected to the initial input ports. The flow control information device may comprise a switch.

Embodiments of the present invention will now be described by way of example with reference to the accompanying drawings, in which:

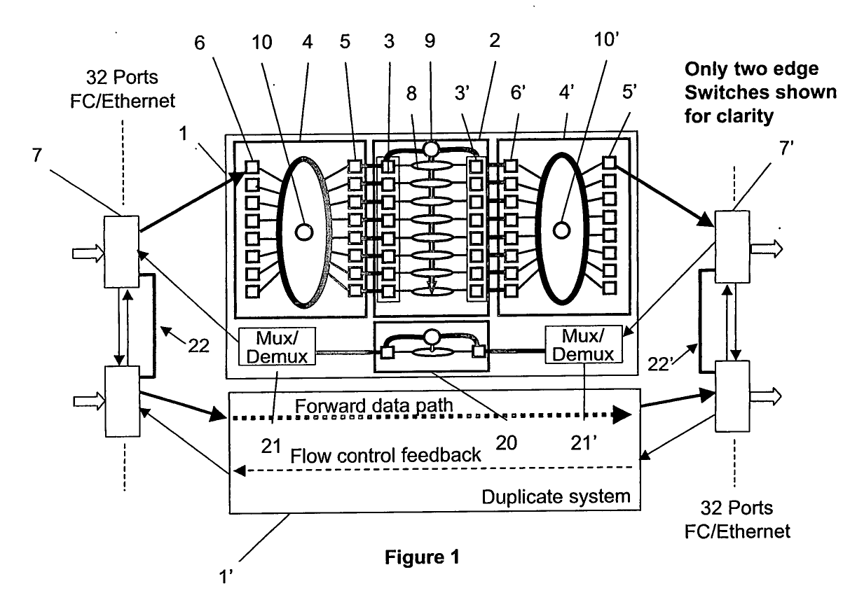

FIG. 1 shows schematically a cross-section through an example of an embodiment of apparatus according to the present invention;

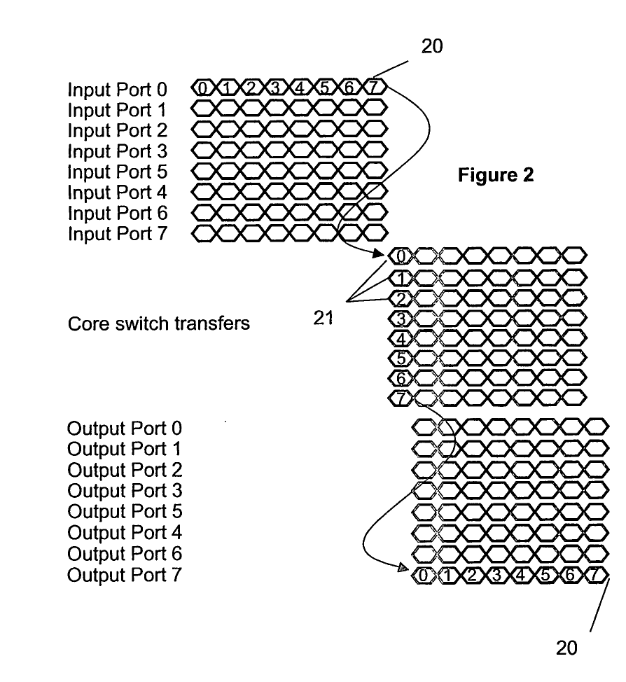

FIG. 2 shows schematically one example of the transfer of data fragments through the core switch;

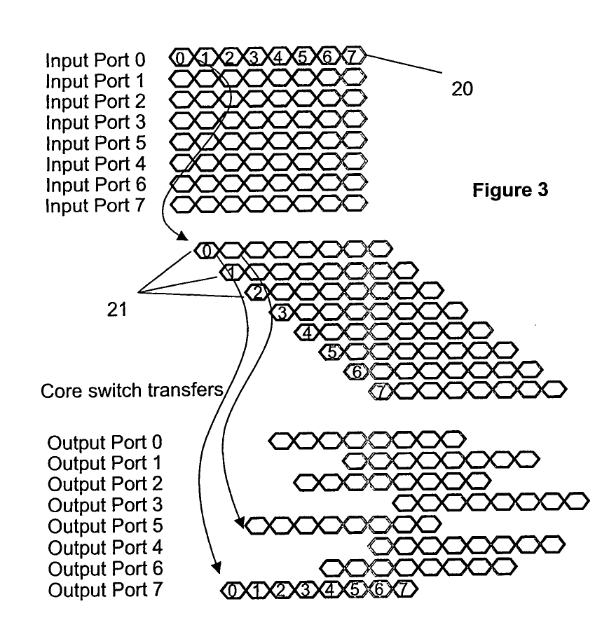

FIG. 3 shows another example of the transfer of data fragments through the core switch;

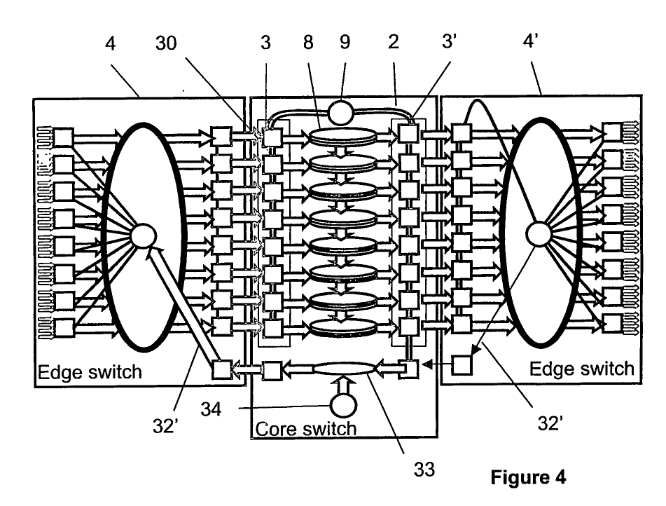

FIG. 4 shows schematically a cross-section through another example of an embodiment of apparatus according to the present invention; and,

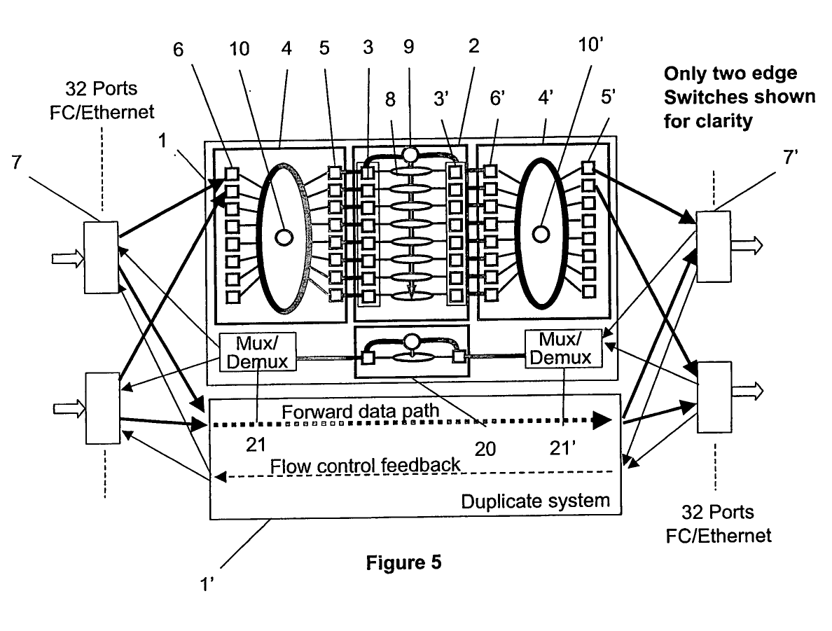

FIG. 5 shows schematically a cross-section through another example of an embodiment of apparatus according to the present invention.

Referring first to FIG. 1, there is shown an example of apparatus 1 according to an embodiment of the present invention. It will be understood that the apparatus is shown schematically and is shown in cross-section.

The apparatus 1 includes a core switch 2. In the preferred embodiment, the core switch 2 is a terabyte-per-second (TB/s) switch having 32 ports 3. Only two ports 3 are shown in the cross-sectional view of FIG. 1. The ports 3 can be considered to be arranged in a circular array when viewed from above (from the top in FIG. 1). Each individual port 3 has a capacity of 320 Gbit/s in both directions. Each port 3 is actually formed of plural port devices or “slices”, eight such slices being shown in the example of FIG. 1, each slice having a capacity of 40 Gbit/s in both directions.

An edge switch 4 is connected to each port 3 of the core switch 2. There are thus 32 such edge switches 4.

For reasons of clarity, the apparatus 1 is shown in FIG. 1 with the input side and output side shown separately, the input side being indicated by unprimed reference numerals and the output being side being shown by primed reference numerals. In practice, the ports 3 of the core switch 2, the edge switches 4, etc. may each be full duplex such that each operates as both an input and an output.

In the following discussion, mention will be made principally of the connection and operation of one edge switch 4 on the input side and one edge switch 4′ on the output side. It will be understood that the connection and operation of the other edge switches will typically be similar.

The detailed connection between the edge switches 4 and the core switch 2 is as follows. Each edge switch 4 has eight output ports 5 which are connected to respective slices of one input port 3 of the core switch 2.

Each input edge switch 4 in this example has eight input ports 6. In one embodiment, each of these input ports 6 is sub-divided into four sub-ports. A respective input interface device 7 (an “outside world” device) is connected to each one of these four sub-ports of the input ports 6. Only two input interface devices 7 are shown in FIG. 1. Each of the four sub-ports of the input ports 6 of the input edge switch 4 has a 10 Gb/s capacity. The input interface devices may be for example Fibre Channel or 10 Gb/s Ethernet devices.

Correspondingly, on the output side, each slice of one output port 3′ of the core switch 2 is respectively connected to one of eight input ports 6′ of the output edge switch 4′. The output edge switch 4′ has eight output ports 5′, each of which is again in this embodiment divided into four sub-ports each of 10 Gb/s capacity. A respective output interface device 7′ (an “outside world” device) is connected to each sub-port of the output ports 5′ of the output edge switch 4′.

Accordingly, considering that in this example there are 32 input and output ports 3,3′ on the core switch 2, and given that an edge switch 4,4′ having eight input/output ports 6,5 is connected to each input/output port 3,3′ of the core switch 2, and further considering that each input/output port 6,5 of the edge switches 4,4′ is sub-divided into four sub-ports with an interface device 7,7′ connected to each, a total of 1,024 (32×8×4) interface devices 7,7′ can be interconnected via the apparatus 1.

The core switch 2 has eight sets of switching planes 8, one for each slice of the ports 3,3′. The switching planes 8 are controlled by a controller 9 of the core switch 2 to connect the port devices of the input and output ports 3,3′ of the core switch to each other as required, in a manner known per se and as discussed for example in the published PCT applications mentioned above. In essence, any input port 3 of the core switch 2 can be connected at will to any output port 3′ of the core switch 2 under control of the core switch controller 9.

The apparatus 1 is optimised for relatively large data packets. If data of a smaller size is to be transferred, it is necessary to pad the data so as to produce the smallest transferable size packet, thus generally resulting in less efficient transfer of the data. The optimal size data packets in one example is nominally 2 kB or 4 kB.

When one of these data packets arrives at an input port 6 (actually, one of the four sub-ports of an input port 6) of the edge switch 4, which operates under the control of its own controller 10, the data packet is split into eight equal sized fragments (of 256B or 512B in this example) by a port device 6 of the edge switch 4. The eight fragments are then each sent to a respective one of the output ports 5 of the edge switch 4. As mentioned above, the output ports 5 of the edge switch 4 are connected to respective slices of the input port 3 of the core switch 2. Accordingly, each data fragment passes to a respective slice of the input port 3 of the core switch 2. The data fragments are then transferred across the core switch 2 to the correct output port 3′ to be passed to input ports 6′ of the output edge switch 4′. The data fragments are passed in sequence to the correct output port 5′ of the output edge switch 4′ and reassembled to reform the data packet, the reformed data packet then being transmitted to the destination interface device 7′.

A detailed example of the flow of the data is shown schematically in FIG. 2, which shows time passing to the right of the figure. Looking first at the top of the figure, a relatively long and narrow data packet 20 is received at an input port 6 of the edge switch 4 (say input port no. 0). In an example, the data packet 20 has a length in the time domain of 2 μs. That data packet 20 is divided into eight fragments. In an example, the data fragments 21 have a length in the time domain of 48 ns. The data fragments 21 are then passed via the output ports 5 of the input edge switch 4 to respective slices of one input port 3 of the core switch 2 (centre part of FIG. 2). The data fragments 21 may be passed simultaneously, or sequentially, or in some other predictable manner. The controller 9 of the core switch 2 controls the switching planes 8 so that the eight data fragments 21 transfer across the core switch 2, in this example substantially simultaneously, effectively as a short wide packet, respectively to arrive at the eight input ports 6′ of the correct output edge switch 4′. From there, the controller 10′ of the output edge switch 4′ causes the data fragments to be transferred sequentially and preferably on consecutive arbitration cycles of the edge switch 4′ to the correct output port 5′ of the output edge switch 4′. This is shown as output port no. 7 in the lower part of FIG. 2. The reassembled data packet is then passed to the correct sub-port on the output port 5′ of the output edge switch 4′ for transmission to the destination output interface device 7′ at the rate permitted by the line data rate.

In the example described above, the data fragments are transferred substantially simultaneously across the core switch 2. An alternative is to skew in time the transfer of the data fragments across the core switch 2, as shown schematically in FIG. 3. By skewing the data fragments in this way, for at least some of the ports the data fragments can emerge on the relevant output port 5′ of the output edge switch 4′ sooner than otherwise, thus potentially reducing latency through the apparatus 1.

In either case, for the links between the edge switches 4,4′ and the core switch 2, it is preferred that any link level retry mechanism is disabled. Instead, end-to-end CRC (Cyclic Redundancy Check) error checking can be used to trap corruptions that escape data path error checking and correction.

In many multistage interconnected networks of switches, blocking of data is a characteristic problem. Accordingly, it is preferred that flow control information is sent back to the input interface devices 7 from the output interface devices 7′. This back flow of information is indicated by relatively thin flow lines in FIG. 1. Again, the flow of control information is shown as being in one direction only for clarity, but it will be understood that the flow will typically be bidirectional.

Ideally, every input interface device 7 knows the status of the data flow on every output interface device 7′ and how much data it is therefore allowed to send, and thus schedules transfers into the apparatus 1 only when it is known that the ultimate destination output interface device 7′ is connected to an unblocked output 5′. In the embodiment shown, this is achieved using a 1 terabit per second switch 20 having 32 ports each running at 40 Gbit/s. A small switch or multiplexer/demultiplexer 21,21′ collects flow control information from 32 interface devices 7,7′ and feeds this data into the 1 Tbit switch 20. Each multiplexer/demultiplexer 21,21′ also receives feedback data from other ports on the 1 Tbit switch 20 and distributes the data to the 32 interface devices 7,7′ that are connected to it. In operation, the 1 Tbit switch 20 cycles around all of its 32 ports typically in turn, broadcasting the received flow control data cells to all other ports on the switch 20 via the multiplexers/demultiplexers 21. In this manner, all input interface devices 7 will know the flow control status of all 1024 output ports of the apparatus 1 within 32 cell times, a cell time being several (e.g. two) clock cycles of the one Tbit switch 20. This method of broadcasting of the status of every output port to every input port is achieved in a very economic manner and avoids the relatively large overhead associated with known mechanisms.

Given that data may already be passing through the apparatus 1 at the time when a STOP message is issued to all input interface devices 7, it is preferred that the user interface devices 7′ have sufficient buffering capacity to ensure that the data that is in-flight through the core and edge switches 2,4,4′ do not overrun the output buffers. Several megabytes of buffering may be required at each interface device 7,7′.

In the example described above, the core switch 2 was said to have eight sets of switching planes 8. This may be increased to nine or ten sets of planes 8 in order to allow for further encapsulation of the data fragments with protocol headers, etc.

Resilience can be provided by in essence duplicating the apparatus 1, as indicated schematically at 1′ in FIG. 5, and connecting each interface device 7,7′ to both sets of apparatus 1,1′. In this configuration, one apparatus 1 operates normally and the other apparatus 1′ is in standby mode so that it is ready to take over the normal operation without loss of performance if the first apparatus 1 fails. In this duplicated configuration, one of the small switches 21,21′ typically serves no useful purpose until there is a failure. An option therefore exists to use these switches to return acknowledgement of successful data packet transfer (ACKs) through the switches so that in the event of data not being transferred successfully, then lack of an acknowledgement or receipt of a negative acknowledgement will cause re-transmission of the packet.

In another resilient configuration, shown schematically in FIG. 1, the system can support up to 2048 ports, with 1024 connected to each apparatus 1,1′. Interface devices may be grouped in pairs as indicated schematically in FIG. 1, each device of each pair being connected to a different apparatus 1,1′. High speed links 22,22′ join the two interface devices 7,7′ of each pair. Data received by either device 7,7′ in the pair will be routed to the other device 7,7′ if that is the intended target for a data packet. If one system fails, then data transfers continue, albeit at half the overall throughput of the resilient system. The data is forwarded using the interface device connected to the remaining functional apparatus 1,1′.

Referring now to FIG. 4, there is shown a variant of the apparatus 1. In this example, the slices of the ports 3,3′ of the core switch 2 are in communication with each other via serial links 30, thereby forming a daisy chain connection. This allows for easy transfer of control information between the slices as required.

In the example of FIG. 1, a separate switch 20 was provided to allow for flow control information to be passed between the interface devices 7,7′. In the example of FIG. 4, the provision of and passing back of flow control information is carried out in a rather different manner. In particular, a control master 31,31′ of each edge switch 4,4′ regularly outputs a summary of its own output flow control information on a spare serial link 32. This serial link connects to a small “reverse direction” switch 33 in the core switch 2, which is shown schematically as a further switching plane 33 in FIG. 4 under control of its own controller 34. Given that every edge switch 4,4′ has its own serial link 32 to this control information switch 33, flow control information can be passed from every interface device 7 to every other interface device 7. The configuration of the switch 33 can be altered according to requirements. For example, one plane 33 as indicated can provide an update of the status of all output ports every 32 switch cycles. On the other hand, if for example 16 switching planes 33 were used, all interface devices 7 can broadcast their status to every other interface device 7 in two switch cycles.

In the examples described above, the core switch 2 is described as having a single master controller 9 for controlling operation of all of the sets of switching planes 8. In a variation, each set of switching planes 8 may have its own master controller.

The present invention provides an apparatus and method that allows for fast switching of large amounts of data. In the preferred embodiment, flow control information that allows every connected interface device to know the status of every other connected interface device is passed around with relatively small overhead. In one embodiment, the switch can switch data at rates of one terabyte per second. In contrast, prior art arrangements have only provided for example 32 ports at 40 Gb/s or 128 ports at 10 Gb/s, in either case giving a switching rate of only one terabit per second.

In the preferred embodiment, each edge switch 4 and core switch 2 is formed of a set of discrete semiconductor devices.

Embodiments of the present invention have been described with particular reference to the example illustrated. However, it will be appreciated that variations and modifications may be made to the examples described within the scope of the present invention. For example, there may be different numbers of input ports 6 and/or output ports 5 of the edge switches 4 than the eight mentioned above. More or less interface devices 7 may be connected to each port 6,5 of each edge switch 4.

Moreover, an option exists to provide a bridging or protocol conversion mechanism whereby one or more of the “outside world” interface devices 7,7′ uses a different communications protocol to other interface devices 7,7′. Also, an option exists for an interface device 7,7′ to provide a caching function for data received from or waiting to be sent to another interface device 7,7′ connected to another port in the system, such that data may be transferred to or from the remote interface at different times, and using different sized transfers than those requested by a computer or other apparatus connected to the said interface device 7,7′. Furthermore an option exists to provide one or more protection mechanisms, such as but not limited to partitioning and exclusion, whereby the ability of an interface device 7,7′ to communicate with other interface devices 7,7′ is controlled from within the apparatus 1, 1′.

1. A method of switching data packets received at initial input ports from input interface devices to output interface devices connected to ultimate output ports, the method comprising:
receiving a data packet from an input interface device at one of a plurality of initial input ports;
dividing the data packet into plural smaller data fragments;
passing each data fragment to a respective one of a plurality of slices of an input port of a core switch;
switching the data fragments using the core switch so as to pass each data fragment to a selected respective one of a plurality of slices of an output port of the core switch;
passing the data fragments to a selected one of a plurality of ultimate output ports;
assembling the data fragments to reform the data packet; and,
transmitting the reformed data packet to an output interface device connected to said selected one of a plurality of ultimate output ports.

2. The method according to claim 1, wherein the initial input ports are provided by input ports of an input edge switch that has output ports respectively connected to the slices of said input port of the core switch, the input edge switch carrying out the division of the data packet into plural smaller data fragments.

3. The method according to claim 1, wherein the ultimate output ports are provided by output ports of an output edge switch that has input ports respectively connected to the slices of said output port of the core switch, the output edge switch carrying out the reforming of the data packet from the data fragments.

4. The method according to claim 1, wherein the core switch has plural input ports to each of which is connected a respective input edge switch, and wherein the core switch has plural output ports to each of which is connected a respective output edge switch.

5. The method according to claim 1, comprising passing flow control information from at least some of the output interface devices to at least some of the input interface devices, said input interface devices being controlled by the flow control information so as to pass a data packet to the initial input ports only when the flow control information relating to the destination output interface device for the data packet indicates that said destination output interface device is able to accept the data packet.

6. The method according to claim 5, comprising passing flow control information from each of the output interface devices to each of the input interface devices.

7. The method according to claim 5, wherein the flow control information is passed from the output interface devices to the input interface devices by a control information switch.

8. An apparatus for switching data packets received at initial input ports from input interface devices to output interface devices connected to ultimate output ports, the apparatus comprising:
a plurality of initial input ports for receiving data packets from input interface devices connected to the initial input ports;
a divider for dividing each data packet received at the initial input ports into plural smaller data fragments;
a core switch having at least one input port that has plural slices each arranged to receive a respective data fragment of a data packet, the core switch having at least one output port that has plural slices, the core switch being controllable to switch said data fragments so as to pass each data fragment to a selected respective one of the plural slices of said at least one output port of the core switch; and,
an assembler for receiving the data fragments from said at least one output port of the core switch, for reforming the data packet from the data fragments, and for transmitting the reformed data packet to an output interface device connected to one of a plurality of ultimate output ports of the apparatus.

9. The apparatus according to claim 8, comprising an input edge switch, the input edge switch having input ports that provide the initial input ports, the input edge switch having output ports respectively connected to the slices of the at least one input port of the core switch, the input edge switch being arranged to carry out the division of a data packet into plural smaller data fragments.

10. The apparatus according to claim 8, comprising an output edge switch, the output edge switch having output ports that provide the ultimate output ports, the output edge switch having input ports respectively connected to the slices of the at least one output port of the core switch, the output edge switch being arranged to carry out the reforming of a data packet from data fragments.

11. The apparatus according to claim 8, wherein the core switch has plural input ports to each of which is connected a respective input edge switch, and wherein the core switch has plural output ports to each of which is connected a respective output edge switch.

12. The apparatus according to claim 8, comprising a flow control information device for passing flow control information from at least some of said output interface devices connected to the ultimate output ports to at least some of said input interface devices connected to the initial input ports so as to control said input interface devices to pass a data packet to the initial input ports only when the flow control information relating to a destination output interface device for the data packet indicates that said destination output interface device is able to accept the data packet.

13. The apparatus according to claim 12, wherein the flow control information device is arranged to pass flow control information from each of said output interface devices connected to the ultimate output ports to each of said input interface devices connected to the initial input ports.

14. The apparatus according to claim 12, wherein the flow control information device comprises a switch.

15. The method according to claim 2, wherein the ultimate output ports are provided by output ports of an output edge switch that has input ports respectively connected to the slices of said output port of the core switch, the output edge switch carrying out the reforming of the data packet from the data fragments.

16. The method according to claim 15, wherein the core switch has plural input ports to each of which is connected a respective input edge switch, and wherein the core switch has plural output ports to each of which is connected a respective output edge switch.

17. The method according to claim 16, comprising passing flow control information from at least some of the output interface devices to at least some of the input interface devices, said input interface devices being controlled by the flow control information so as to pass a data packet to the initial input ports only when the flow control information relating to the destination output interface device for the data packet indicates that said destination output interface device is able to accept the data packet.

18. The apparatus according to claim 9, comprising an output edge switch, the output edge switch having output ports that provide the ultimate output ports, the output edge switch having input ports respectively connected to the slices of the at least one output port of the core switch, the output edge switch being arranged to carry out the reforming of a data packet from data fragments.

19. The apparatus according to claim 18, wherein the core switch has plural input ports to each of which is connected a respective input edge switch, and wherein the core switch has plural output ports to each of which is connected a respective output edge switch.

20. The apparatus according to claim 19, comprising a flow control information device for passing flow control information from at least some of said output interface devices connected to the ultimate output ports to at least some of said input interface devices connected to the initial input ports so as to control said input interface devices to pass a data packet to the initial input ports only when the flow control information relating to a destination output interface device for the data packet indicates that said destination output interface device is able to accept the data packet.
